(19) United States
(12) Patent Application Publication
(10) Pub. No.: US 2013/0034747 A1
(43) Pub. Date: Feb. 7, 2013

(54) PERPENDICULAR MAGNETIC RECORDING MEDIUM AND METHOD FOR MANUFACTURING SAME

(71) Applicant: Katsumi TANIGUCHI, Matsumoto-city (JP)

(72) Inventor: Katsumi TANIGUCHI, Matsumoto-city (JP)

(73) Assignee: FUJI ELECTRIC CO., LTD., Kawasaki-shi (JP)

(21) Appl. No.: 13/566,838

(22) Filed: Aug. 3, 2012

(30) Foreign Application Priority Data
Aug. 4, 2011 (JP) 2011-171012

(51) Int. Cl. G11B 5/851; G11B 5/72; G11B 5/65

(52) U.S. Cl. 428/835.1; 204/192.15

(57) ABSTRACT

A method for manufacturing a perpendicular magnetic recording medium can suppress the increase in head spacing and decrease in magnetic anisotropy of a magnetic layer. The method includes forming the magnetic recording layer and a protective layer precursor. The magnetic recording layer includes crystal grains of an ordered alloy and a grain boundary layer constituted by carbon and is formed on the non-magnetic substrate by a sputtering method using a target including metals constituting the ordered alloy and carbon. The protective layer precursor is constituted by carbon and is present on the magnetic recording layer. The method further includes irradiating the protective layer precursor with hydrocarbon ions generated by plasma discharge in a hydrocarbon gas and changing the protective layer precursor into the protective layer. The hydrocarbon ions have energy equal to or higher than 300 eV when the hydrocarbon ions reach the protective layer precursor.

### BACKGROUND OF THE INVENTION

1. Field of the Invention

The present invention relates to a perpendicular magnetic recording medium installed in various magnetic recording devices such as external recording devices for computers.

2. Description of the Related Art

Two systems, namely, an in-plane magnetic recording system and a perpendicular magnetic recording system, are used in magnetic recording media such as hard disks, magnetooptical (MO) disks, and magnetic tapes. The in-plane magnetic recording system in which magnetic recording is performed horizontally with respect to the disk surface has been used for a long time in hard disks. However, the problem due to the thermal fluctuations occurs notably in such a system. That is, as recording magnetization is refined as the recording density increases, the refined recording magnetization is lost under the effect of thermal energy. In the in-plane magnetic recording system, another problem that became obvious is that instability is enhanced at the locations where magnetizations of the same polarity oppose together as the recording density increases. With the foregoing in view, a perpendicular magnetic recording system in which magnetic recording is performed perpendicularly to the disk surface and which makes it possible to obtain a higher magnetic density has been used since 2005. The perpendicular magnetic recording system is presently used in practically all of the magnetic recording media.

Co—Cr-type disordered alloy magnetic films such as CoCrPt films have been mainly used as metallic magnetic materials for perpendicular magnetic recording media. However, in the perpendicular magnetic recording media, it is also possible that the problem of thermal fluctuations will be encountered in the future as the recording density increases. With this in mind, materials with a perpendicular magnetic anisotropy higher than that of the conventional CoCr-type disordered alloys are useful. Ordered alloy materials in which at least one magnetic element selected from the group including Fe, Co, and Ni and at least one noble metal element selected from the group including Pt, Pd, Au, and Ir form an ordered phase have been actively studied as effective candidates for such materials (see, for example, Japanese Patent Application Publication Nos. 2002-208129, 2003-173511, 2002-216330, 2004-311607, and 2001-101645, and WO 2004/034385). In particular, FePt, which is a L1₀-type ordered alloy having a face-centered tetragonal (fct) crystal structure, has a magnetic anisotropy of 7×10⁷ erg/cm³ (7×10⁶ J/m³) in the c axis direction, which is an axis of easy magnetization, this value being more than two times the value that is presently obtained in the CoCr-type disordered alloy materials.

In order to use the FePt L1₀-type ordered alloy as a magnetic layer of a perpendicular magnetic recording medium, it is useful to add a nonmagnetic material and form a granular structure in which crystal grains of the ordered alloy are magnetically separated. Oxide materials such as SiO₂ and TiO₂ that are used in CoCr-type disordered alloy magnetic films (see, for example, Japanese Patent Application Publication No. 2002-208129 and WO 2004/034385), non-magnetic ordered alloys (see, for example, Japanese Patent Application Publication No. 2003-173511), or carbon materials (see, for example, Japanese Patent Application Publication No. 2004-152471) have been studied as the non-magnetic materials to be added. Japanese Patent Application Publication No. 2004-152471 indicates that carbon materials are effective candidates among the aforementioned materials.

### SUMMARY OF THE INVENTION

A magnetic film having a granular structure constituted by the FePt L1₀-type ordered alloy and carbon (referred to hereinbelow as FePt—C) is formed by depositing Fe, Pt, and C by sputtering, while heating a substrate for film formation. In this case, it is suggested that carbon should be added at a ratio of about 25 at. % (atomic percent) or more, based on FePt, in order to completely separate the grain boundaries of FePt ordered alloy grains with carbon (see Japanese Patent Application Publication No. 2004-152471). However, the research conducted by the inventors has demonstrated that when the amount of carbon added is equal to or higher than 25 at. %, the carbon not only precipitates on the grain boundaries of FePt grains, but also on the surface of the FePt grains as the FePt L1₀-type ordered structure is formed. FIG. 1 shows the relationship between an Ar plasma treatment time and Fe, Pt, and C detection intensity (number of counts) in surface analysis by XPS (X-ray photoelectron spectroscopy) in the case where the surface of a FePt—C layer formed by using a target with a carbon amount of 25 at. % is etched by using Ar plasma. FIG. 1 clearly indicates that the detection intensity of carbon decreases and the detection intensity of Fe and Pt somewhat increases with time of Ar plasma treatment (etching treatment). This result demonstrates that carbon precipitates on the grain boundary of FePt grains and also precipitates on the surface of FePt grains. The reason for carbon precipitating on the FePt grain surface is presently unclear.

Where a protective layer of diamond-like carbon (referred to hereinbelow as DLC) that has been conventionally used to protect magnetic layers is formed after the carbon (graphite-like) has precipitated on the surface of FePt grains, the distance from the DLC protective film surface to the FePt grain surface increases due to the presence of carbon therebetween. This corresponds to the increase in distance between a magnetic head and a magnetic layer (head spacing) and causes a decrease in recording density.

Meanwhile, a method for removing carbon that has precipitated on the FePt grains surface by using a technique such as etching with inactive gas plasma in order to prevent the increase in head spacing can be considered. However, ion bombardment of the FePt grain surface can cause etching of FePt and destruction of the L1₀-type ordered structure, thereby decreasing magnetic anisotropy of the magnetic layer.

The present invention relates to a method for manufacturing a perpendicular magnetic recording medium including: (1) a step of forming the magnetic recording layer and a protective layer precursor, wherein the magnetic recording layer which includes crystal grains of an ordered alloy and a grain boundary layer constituted by carbon and the magnetic recording layer is formed on the non-magnetic substrate by a sputtering method using a target including metals constituting the ordered alloy and carbon, and wherein the protective layer precursor, which is constituted by carbon, is present on the magnetic recording layer; and

(2) a step of irradiating the protective layer precursor with hydrocarbon ions generated by plasma discharge in a hydrocarbon gas and changing the protective layer precursor into the protective layer, wherein the hydrocarbon ions have energy equal to or higher than 300 eV when the hydrocarbon ions reach the protective layer precursor.

The ordered alloy preferably has a L1₀-type ordered structure and is preferably a FePt alloy. It is desirable that the step (2) be performed immediately after the step (1). The obtained protective layer is preferably from diamond-like carbon. The hydrocarbon gas used in step (2) is preferably C₂H₄ or C₂H₂.

The present invention also relates to a perpendicular magnetic recording medium manufactured by the above-mentioned manufacturing method.

By using the above-described features, it is possible to form a protective layer that is constituted by DLC with a significant fraction of sp³ bonds and has a small thickness on the surface of a magnetic recording layer. As a result, the increase in head spacing of a magnetic recording medium can be suppressed and the recording density can be increased. Further, with the method in accordance with the present invention a step of removing carbon precipitated on the surface of the magnetic recording layer when the layer is formed is not required. Therefore, it is possible to suppress the etching of crystal grains of the ordered alloy in the magnetic recording medium and the fracture of the L1₀-type ordered structure and maintain large magnetic anisotropy of the magnetic recording layer.

### BRIEF DESCRIPTION OF THE DRAWINGS

FIG. 1 is a graph showing the relationship between the Ar plasma treatment time and the Fe, Pt, and C detection intensity in surface analysis by XPS in the case where the surface of a FePt—C layer formed by using a target with a carbon amount of 25 at. % is etched by Ar plasma;

FIG. 2 is a cross-sectional view illustrating an example of the perpendicular magnetic recording medium in accordance with the present invention;

FIG. 3 is a cross-sectional view illustrating a layer immediately after the ordered alloy and carbon have been deposited in the method for manufacturing the perpendicular magnetic recording medium in accordance with the present invention;

FIG. 4 is a graph illustrating the relationship between the irradiation time and the thickness of a protective layer precursor 60a in the case where the protective layer precursor 60a is irradiated with hydrocarbon ions; and

FIG. 5 is a graph showing the Raman scattering spectrum of a specimen obtained by irradiating the protective layer precursor 60a with hydrocarbon ions for 2 sec.

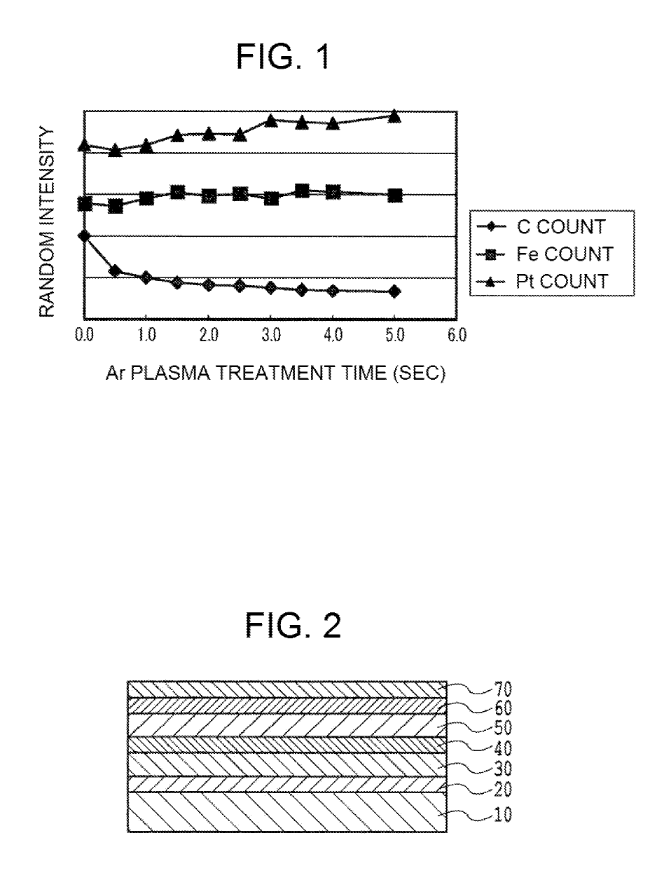

### DETAILED DESCRIPTION

FIG. 2 shows an exemplary configuration of the perpendicular magnetic recording medium in accordance with the present invention. The perpendicular magnetic recording medium shown in FIG. 2 includes a soft magnetic underlayer 20, a non-magnetic underlayer 30, a non-magnetic intermediate layer 40, a magnetic recording layer 50, a protective layer 60, and a lubricating layer 70 on a non-magnetic substrate 10. Among these layers, the soft magnetic underlayer 20, non-magnetic underlayer 30, non-magnetic intermediate layer 40, and lubricating layer 70 are optionally selected and provided.

Various substrates with a smooth surface that are known in the pertinent field can be used as the non-magnetic substrate 10. For example, a NiP-plated Al alloy, reinforced glass, and crystallized glass that are used in the conventional magnetic recording media can be used as the non-magnetic substrate 10.

The soft magnetic underlayer 20 has a function of concentrating the magnetic flux generated by a magnetic head in the magnetic recording layer when recording is performed on the magnetic recording layer. The soft magnetic underlayer 20 can be formed using a crystalline material such as FeTaC and a sendast (FeSiAl) alloy, or an amorphous material including a Co alloy such as CoZrNb and CoTaZr. The optimum value of the film thickness of the soft magnetic underlayer 20 varies depending on the structure and properties of the magnetic head used for recording, but is preferably about 10 nm to 500 nm with consideration for balance with productivity.

The non-magnetic underlayer 30, which is an optional layer, may be provided to ensure adhesion between the soft magnetic underlayer 20 and the non-magnetic intermediate layer 40 and to cause (001) orientation of the non-magnetic intermediate layer 40. The non-magnetic underlayer 30 can be formed by using an alloy including NiW, Ta, Cr, or Ta and/or Cr. The non-magnetic underlayer 30 may have a laminated structure constituted by a plurality of layers including the aforementioned materials. With consideration for the improvement of crystallinity of the non-magnetic intermediate layer 40 and the magnetic recording layer 50, increase in productivity, and optimization of the magnetic field generated by the head during recording, it is desirable that the non-magnetic underlayer 30 have a thickness of 1 nm to 20 nm.

The non-magnetic intermediate layer 40 serves to cause (001) orientation (that is, to enable perpendicular magnetic recording) of the crystals of the ordered alloy in the magnetic recording layer 50. The non-magnetic intermediate layer 40 can be formed using a metal such as Cr, Pt, Pd, Au, Fe, or Ni, an alloy including the aforementioned metals (a NiAl alloy and the like) or a compound such as MgO, LiF, and NiO. From the standpoint of preventing the diffusion of material between the magnetic recording layer 50 and the layer located below the non-magnetic intermediate layer 40, it is preferred that the non-magnetic intermediate layer 40 be formed using MgO.

The magnetic recording layer 50 has a granular structure constituted by magnetic crystal grains constituted by an ordered alloy and a non-magnetic matrix for magnetically separating the magnetic crystal grains. The ordered alloy that can be used in accordance with the present invention is preferably a L1₀-type ordered alloy. In the L1₀-type ordered alloy, at least one magnetic metal element selected from the group including Fe, Co, and Ni and at least one noble metal element selected from the group including Pt, Pd, Au, and Ir form an ordered phase. Elements such as Cu and Ag may be included as additives. The preferred L1₀-type ordered alloys include CoPt, FePt, and alloys obtained by adding Ni or Cu thereto. The L1₀-type ordered alloy in the magnetic recording layer 50 has a (001) orientation. The non-magnetic matrix in accordance with the present invention is carbon. By using a magnetic material with a granular structure, it is possible to enhance magnetic separation between adjacent magnetic crystal grains in the magnetic recording layer 50 and improve medium characteristics (noise reduction, SNR increase, increase in recording resolution, etc.). The thickness of the magnetic recording layer 50 is not particularly limited. However, from the standpoint of obtaining high productivity and also a high recording density, it is preferred that the magnetic recording layer 50 have a thickness equal to or less than 30 nm, preferably equal to or less than 15 nm.

The protective layer 60 serves to protect the underlying constituent layers including the magnetic recording layer 50. The protective layer 60 in accordance with the present invention is formed by diamond-like carbon (DLC). In accordance with the present invention, where peaks appear close to 1350 cm⁻¹ and close to 1580 cm⁻¹ when the protective layer 60 is analyzed by using Raman spectroscopy, it can be assumed that the protective layer 60 has been formed from diamond-like carbon (DLC).

The lubricating layer 70 can be formed using a liquid lubricating agent such as PFPE (perfluoropolyether).

A method for manufacturing the perpendicular magnetic recording medium in accordance with the present invention will be described below. Initially, the soft magnetic underlayer 20, non-magnetic underlayer 30, and/or non-magnetic intermediate layer 40 are formed on the non-magnetic substrate 10. The aforementioned layers can be formed using a sputtering method (DC magnetron sputtering method, RF magnetron sputtering method, and the like), a vapor deposition method, and the like.

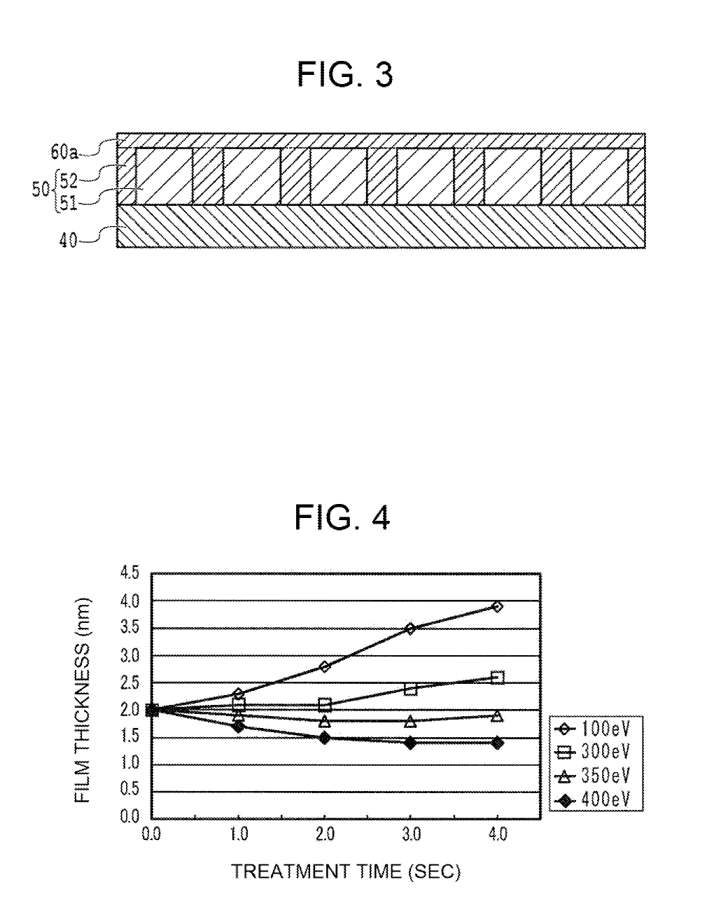

Then, the magnetic recording layer 50 including crystal grains 51 of an ordered alloy and a grain boundary layer 52 constituted by carbon (e.g., graphite) and present in grain boundaries of the crystal grains 51 and also a protective layer precursor 60a constituted by carbon (e.g., graphite) and present on the surface of the crystal grains 51 are formed by a sputtering method using a target in which carbon is mixed with the metals (magnetic metal and noble metal) constituting the ordered alloy. FIG. 3 shows an example in which the magnetic recording layer 50 and the protective layer precursor 60a are formed on the non-magnetic intermediate layer 40.

The amount of carbon added to the target is preferably equal to or greater than 25 at. %, based on the total amount of metals forming the ordered alloy, in order to separate magnetically the crystal grains 51 from each other in this step. Further, in order to enhance the ordering of the crystal grains 51 of the ordered alloy, it is preferred that the substrate where the film is formed (the non-magnetic substrate 10 or the non-magnetic substrate 10 having the adequate constituent layers formed thereon) be heated to a temperature of 300 to 500° C.

The protective layer precursor 60a is then irradiated with hydrocarbon ions generated by plasma discharge in hydrocarbon gas, the carbon (e.g., graphite) in the protective layer precursor 60a is hardened, and the protective layer 60 is formed. In accordance with the present invention, the hardening as referred to herein means a transition from a state with a significant fraction of sp² bonds (for example, graphite) to a state with a significant fraction of sp³ bonds (for example, DLC). An electron cyclotron wave resonance (ECWR) ion source, an electron cyclotron resonance (ECR) ion source, and an inductively coupled plasma (ICP) ion source can be used as the source of the hydrocarbon ions. From the standpoint of facilitating the energy control of ions generated in plasma, it is preferred that the ECWR ion source, from among the aforementioned ion sources, be used (Japanese Patent Application Publication No. 2008-77833 and J. Robertson, Thin Solid Films, 383 (2001), 81-88).

The hydrocarbon gases that can be used in accordance with the present invention include methane (CH₄), ethylene (C₂H₄), and acetylene (C₂H₂). In order to induce plasma discharge and generate hydrocarbon ions with higher efficiency, it is desirable that the pressure of the hydrocarbon gas be within a range of 0.01 Pa to 0.1 Pa.

In accordance with the present invention, hardening of the protective layer precursor 60a is performed at a hydrocarbon ion energy equal to or higher than 300 eV, preferably within a range of 300 eV to 400 eV. The “hydrocarbon ion energy” as referred to herein means the energy of the hydrocarbon ions when they reach the protective layer precursor 60a.

Further, in accordance with the present invention, it is desirable that the irradiation time of hydrocarbon ions be equal to or shorter than 2 sec, preferably 0.5 sec to 2 sec. Where the irradiation is performed with hydrocarbon ions having the energy within the aforementioned range for a time within the aforementioned range, it is possible to harden the protective layer precursor 60a, without increasing the thickness of the protective layer 60.

Further, the lubricating layer 70 may be formed by coating a liquid lubricating agent by using any coating technique well known in the pertinent field, such as a dip coating method and a spin coating method, on the protective layer 60 formed in the above-described manner. Optionally, heating or ultraviolet radiation (UV) treatment may be performed after coating the liquid lubricating agent. Alternatively, the surface of the protective layer 60 may be treated by nitrogen gas plasma prior to coating to terminate the surface of the protective layer 60 with nitrogen atoms and increase the bonded ratio of the protective layer 60 and the liquid lubricating agent.

### Example 1

A glass substrate was prepared as the non-magnetic substrate 10. The non-magnetic substrate 10 was disposed in an ultrahigh-vacuum (UHV) DC/RF magnetron sputtering device (ANELVA, E8001). With a target in the form of a mixture of Fe, Pt, and carbon being used, the substrate being heated to 350° C., and 1 kW high-frequency (RF) power being supplied into the Ar atmosphere under a pressure of 3.0 Pa, the magnetic recording layer 50 and the protective layer precursor 60a were formed. The magnetic recording layer 50 included crystal grains 51 of a FePt L1₀-type ordered alloy and the grain boundary layer 52 constituted by carbon which form grain boundaries of the crystal grains 51. The protective layer precursor 60a was constituted by carbon (graphite) and present on the surface of the crystal grains 51. The content of carbon in the target was 30 at. %, on the basis of a total of Fe and Pt. The total thickness of the obtained magnetic recording layer 50 and protective layer precursor 60a was 5 nm and the thickness of the protective layer precursor 60a was 2 nm.

The laminate including the protective layer precursor 60a was placed into a chamber connected to an ECRW ion source. Then, C₂H₄ gas was introduced by using a mass flow controller so as to obtain a pressure of 0.05 Pa inside the chamber. High-frequency power of 500 W to 3000 W was fed to the ECRW ion source, plasma discharge was induced, and hydrocarbon ions including C₂H₂⁺ and C₂H₄⁺ as the main components were generated.

The output of the high-frequency power (RF power) and the energy of hydrocarbon ions reaching the surface of the protective layer precursor 60a are shown in Table 1.

TABLE 1
Table 1: Energy of hydrocarbon ion vs. output of high-
frequency power

| RF output (W) | Ion energy (eV) |
|---|---|
| 500 | 100 |
| 1500 | 300 |
| 2000 | 350 |
| 3000 | 400 |

FIG. 4 shows the relationship between the irradiation time and thickness variation of the protective layer precursor 60a in the case where the protective layer precursor 60a is irradiated with hydrocarbon ions generated under the conditions shown in Table 1. The thickness of the carbon layer 60 was calculated by measuring the integrated intensity of carbon by XPS. A calibration curve of the film thickness determined by cross-sectional observations performed with a transmission electron microscope (TEM) and the integral intensity of carbon measured by XPS was used to convert the integral intensity of carbon into the film thickness.

When the energy of the hydrocarbon ions was small (100 eV, RF output=500 W), the thickness of the protective layer precursor 60a increased with the increase in irradiation time. This is apparently because a carbon layer deriving from hydrocarbon ions as a starting material has deposited on the protective layer precursor 60a.

Meanwhile, when the energy of the hydrocarbon ions is 300 eV (RF output=1500 W), the thickness of the protective layer precursor 60a practically does not change at the initial stage of hydrocarbon ion irradiation (irradiation time is equal to or shorter than 2 sec), and then the thickness increases. Apparently, at the initial stage of irradiation, hydrocarbon ions collide with the protective layer precursor 60a, a state of equilibrium is assumed between etching of the protective layer precursor 60a, implantation of the hydrocarbon ions, and adhesion of the hydrocarbon ions, and the film thickness practically does not change. Meanwhile, it can be assumed that at the later stage of irradiation (irradiation time is longer than 2 sec), the etching amount of the protective layer precursor 60a decreases and therefore the film thickness increases. Thus, it can be assumed that carbon in the protective layer precursor 60a changes from a state with a significant fraction of sp² bonds to a state with a significant fraction of sp³ bonds and is hardened.

Further, when the energy of the hydrocarbon ions is high (350 eV, RF output=2000 W; 400 eV, RF output=3000 W), the etching amount of the protective layer precursor 60a is large at the initial stage of irradiation and the thickness of the protective layer precursor 60a decreases. As the hardening of the protective layer precursor 60a thereafter advances, the decrease in film thickness is stopped (energy=400 eV) or the film thickness increases (energy=350 eV).

The Raman scattering spectrum of the surface of the layer 51 was measured in the case where the layer 51 was irradiated for 2 sec with hydrocarbon ions generated under the conditions shown in Table 1. With the Raman scattering spectroscopy, a sample surface is irradiated with light (visible light, infrared radiation, etc.), variations in frequency of the scattered light caused by oscillations of atoms or lattice of the sample are monitored, and the sample state is analyzed. In the Raman scattering spectrum, changes (Raman shift; with respect to the irradiation light) of frequency (energy) of the scattered light are plotted against the abscissa and the spectral intensity is plotted against the ordinate. A peak at 1333 cm⁻¹ in diamond and a peak at 1582 cm⁻¹ in highly oriented graphite are known as peaks of a typical Raman spectrum in a crystalline carbon material. In the case of a DLC film, a spectrum different from that of a crystalline material can be observed due to an amorphous state (see A. C. Ferrari and J. Robertson, Phys. Rev. B, Vol. 61, No. 20 (2000), 14,095-14,107). In a DLC film, a spectrum is obtained in which a peak (D band) close to 1350 cm⁻¹ that is caused by disordering and microcrystallinity of the crystal structure and a peak (G band) close to 1550 cm⁻¹ that is caused by a graphite structure overlap. The fraction of sp³ bonds increases as the peak position of the G band shifts to a low frequency side (low energy side).

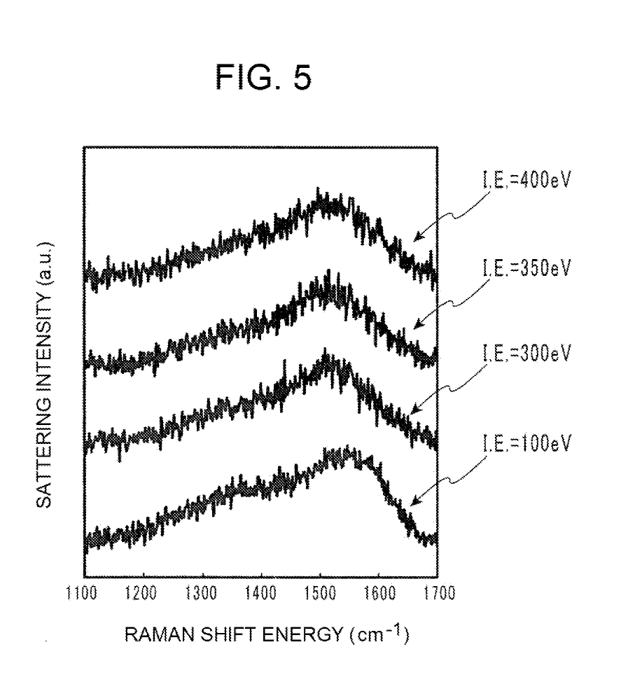

FIG. 5 shows Raman scattering spectra measured by using a laser beam with a wavelength of 530 nm as an irradiation source. In each Raman scattering spectrum shown in FIG. 5, the intensity decreases since the thickness of the carbon layer (protective layer precursor 60a or protective layer 60) is small, but peaks are present at positions corresponding to the D band and G band, and a spectrum wavelength inherent to DLC is obtained. Therefore, it is clear that the protective layer precursor 60a has changed into the protective layer 60 constituted by DLC under the irradiation with hydrocarbon ions.

The energy (I. E.) of the hydrocarbon ions, the thickness of the protective layer 60 calculated from the measurement results of XPS, and the peak position (Raman shift) of the G band determined at a wavelength separation from the Raman scattering spectra are shown in Table 2. The peak position of the G band in the case of irradiation with hydrocarbon ions at an energy of 300 eV has moved by 35 cm⁻¹ to the low frequency side with respect to the peak position of the G band in the case of irradiation with hydrocarbon ions at an energy of 100 eV. The peak position of the G band in the case of irradiation with hydrocarbon ions at an energy equal to or higher than 300 eV does not change significantly with respect to the peak position of the G band in the case of irradiation with hydrocarbon ions at an energy of 300 eV. Therefore, under irradiation with hydrocarbon ions at an energy equal to or higher than 300 eV, the protective layer 60 becomes a DLC film with a fraction of sp³ bonds higher than that obtained under irradiation with hydrocarbon ions at an energy of 100 eV.

TABLE 2
Table 2: Thickness of carbon layer and Raman shift of G band
under irradiation with hydrocarbon ions for 2 sec

| | | Raman shift of G |
|---|---|---|
| Ion energy (eV) | Film thickness (nm) | band (cm⁻¹) |
| 100 | 2.8 | 1557 |
| 300 | 2.1 | 1522 |
| 350 | 1.8 | 1515 |
| 400 | 1.5 | 1520 |

These results clearly indicate that the protective layer precursor 60a can be modified into the protective layer 60 constituted by DLC with a significant fraction of sp³ bonds by irradiating the protective layer precursor 60a, which has been precipitated on the surface of the magnetic recording layer 50 (crystal grains 51 of the FePt ordered alloy) when a FePt L1₀-type ordered alloy was formed, with hydrocarbon ions generated by a plasma discharge using a hydrocarbon gas as a raw material and having an energy equal to or higher than 300 eV.

With the method in accordance with the present invention, the protective layer 60 constituted by DLC with a significant fraction of sp³ bonds and having a small thickness can be formed on the surface of the magnetic layer 50 including crystal grains 51 of a L1₀-type ordered alloy, such as FePt, that are magnetically separated by the grain boundary layer 52 constituted by carbon. This makes it possible to inhibit the increase in the head spacing of the magnetic recording medium and increase the recording density. Further, with the method in accordance with the present invention, a step of removing the carbon that has precipitated on the surface of the magnetic recording layer 50 when the layer is formed is not required. Therefore, etching of the crystal grains 51 of the ordered alloy present in the magnetic recording layer 50 and the destruction of the L1₀-type ordered structure can be inhibited and large magnetic anisotropy of the magnetic recording layer 50 can be maintained.

What is claimed is:

1. A method for manufacturing a perpendicular magnetic recording medium comprising a non-magnetic substrate, a magnetic recording layer, and a protective layer,
the method comprising:
(1) a step of forming the magnetic recording layer and a protective layer precursor,
wherein the magnetic recording layer includes crystal grains of an ordered alloy and a grain boundary layer constituted by carbon and the magnetic recording layer is formed on the non-magnetic substrate by a sputtering method using a target including metals constituting the ordered alloy and carbon, and
wherein the protective layer precursor is constituted by carbon and is present on the magnetic recording layer; and
(2) a step of irradiating the protective layer precursor with hydrocarbon ions generated by plasma discharge in a hydrocarbon gas and changing the protective layer precursor into the protective layer, wherein
the hydrocarbon ions have energy equal to or higher than 300 eV when the hydrocarbon ions reach the protective layer precursor.

2. The method for manufacturing a perpendicular magnetic recording medium according to claim 1, wherein the ordered alloy has a L1₀-type ordered structure.

3. The method for manufacturing a perpendicular magnetic recording medium according to claim 2, wherein the ordered alloy is a FePt alloy.

4. The method for manufacturing a perpendicular magnetic recording medium according to claim 1, wherein the step (2) is performed immediately after the step (1).

5. The method for manufacturing a perpendicular magnetic recording medium according to claim 1, wherein the protective layer is from diamond-like carbon.

6. The method for manufacturing a perpendicular magnetic recording medium according to claim 1, wherein the hydrocarbon gas is C₂H₄ or C₂H₂.

7. A perpendicular magnetic recording medium manufactured by the manufacturing method according to claim 1.

8. A method comprising:
forming a layer of a magnetic recording medium on a substrate, the layer including starting materials of a protective layer precursor; and
applying conditions to the layer to change the protective layer precursor into a protective layer over a magnetic recording layer.

9. The method of claim 8, further comprising:
including, in the starting materials, carbon and crystal grains of an ordered alloy; and
causing the starting materials to be arranged into a matrix comprising the crystal grains separated by the carbon.

10. The method of claim 8, wherein applying the conditions includes irradiating the layer with hydrocarbon ions.

11. The method of claim 8, wherein applying the conditions includes causing the protective layer precursor to form a diamond-like carbon.

12. The method of claim 9, wherein applying the conditions includes heating the layer to facilitate separating the crystal grains from the carbon.

13. The method of claim 10, comprising imparting to the hydrocarbon ions an energy of at least 300 eV.

14. The method of claim 9, comprising including, in the crystal grains of the ordered alloy, an FePt alloy.

15. The method of claim 10, comprising generating the hydrocarbon ions by a plasma discharge in a hydrocarbon gas including C₂H₄ or C₂H₂.

16. The method of claim 8, wherein forming the layer of the magnetic recording medium includes forming a mixture of carbon and an ordered alloy, and applying the mixture to the substrate with sputtering.

17. The method of claim 16, wherein applying the conditions includes exposing the layer to a hydrocarbon gas under controlled pressure.

18. The method of claim 17, wherein applying the conditions further includes inducing a plasma discharge to generate hydrocarbon ions from the hydrocarbon gas.

19. The method of claim 16, wherein applying the conditions includes heating the substrate.

20. A magnetic recording medium formed by the method of claim 8.
